(19) United States
(12) Patent Application Publication
(10) Pub. No.: US 2014/0212866 A1
(43) Pub. Date: Jul. 31, 2014

(54) METHOD OF INDUCING LEARNER TO LOG INTO LEARNING CONTENT-PROVIDING SERVER

(71) Applicant: TERACLE, INC., SEOUL (KR)

(72) Inventors: In Je CHO, Seoul (KR); Hoon Je CHO, Seoul (KR)

(73) Assignee: TERACLE, INC., Seoul (KR)

(21) Appl. No.: 14/163,920

(22) Filed: Jan. 24, 2014

(30) Foreign Application Priority Data
Jan. 25, 2013 (KR) 10-2013-0008847

(51) Int. Cl. G09B 5/08

(52) U.S. Cl. CPC G09B 5/08
USPC 434/362

(57) ABSTRACT

A method of inducing a learner to log into a learning content-providing server, which is performed by a learner terminal, the method including: receiving an input of uniform resource locator (URL) information that is printed in a textbook; accessing a location in the learning content-providing server, which corresponds to the URL information; receiving and playing a learning content file, which is stored in the location in the learning content-providing server; and if a period or number of times the received learning content file is played expires, frequently accessing the learning content-providing server and requesting to extend the period or number of times the learning content file is played.

### RELATED APPLICATIONS

This application claims the benefit of Korean Patent Application No. 10-2013-0008847, filed on Jan. 25, 2013, in the Korean Intellectual Property Office, the disclosure of which is incorporated herein in its entirety by reference.

### BACKGROUND

1. Field

One or more embodiments of the present invention relate to a method of inducing a learner to log into a learning content-providing server, and more particularly, to a method of inducing a learner to log into a learning content-providing server, so as to induce the learner to frequently access the learning content-providing server by using a learner terminal.

2. Description of the Related Art

With the increase in interest in education, when an educational textbook is developed, a service for providing a video clip or a voice file to help a learner to efficiently study may be provided.

Such a video clip or a voice file is stored in a learning content-providing server and is provided, so that a learner may directly access and download the video clip or the voice file.

However, in this case, if a learner accesses the learning content-providing service once and downloads a textbook, a video clip, or a voice file thereof, the learner may not need to access the learning content-providing server any more. Thus, there is a limit to providing various services to the learner through the learning content-providing server.

### SUMMARY

One or more embodiments of the present invention include a method of solving the above-described problem. The method is to limit a period or number of times a learning content file for a textbook or an e-book that is downloaded through a learner terminal is played, so that a learner frequently accesses a learning content-providing server to update the period or number of times the learning content file is played.

One or more embodiments of the present invention include a method in which uniform resource locator (URL) information for explaining particular terms or questions is inserted into a textbook or an e-book, so that a learner is induced to frequently access the learning content-providing server while studying to download and use explanations of the particular terms and questions.

One or more embodiments of the present invention include a method in which a point is provided to a member whenever the member logs into the learning content-providing server so that a period or number of times the learning content file is played is updated or a relevant textbook may be purchased free of charge or at a discounted price by using the point. Thus, a learner may be induced to frequently access the learning content-providing server.

Additional aspects will be set forth in part in the description which follows and, in part, will be apparent from the description, or may be learned by practice of the presented embodiments.

According to one or more embodiments of the present invention, a method of inducing a learner to log into a learning content-providing server, which is performed by a learner terminal, includes receiving an input of uniform resource locator (URL) information that is printed in a textbook; accessing a location in the learning content-providing server, which corresponds to the URL information; receiving and playing a learning content file, which is stored in the location in the learning content-providing server; and if a period or number of times the received learning content file is played expires, accessing the learning content-providing server and requesting to extend the period or number of times the learning content file is played.

The receiving of the input of the URL information may include: capturing a two-dimensional (2D) barcode that is printed in a textbook; and reading the captured 2D barcode, and displaying URL information that is extracted through the reading of the captured 2D barcode.

The learning content file may be at least one of a video file for the textbook, a video file that includes a detailed explanation of a particular part, a three-dimensional (3D) image file for a 2D image, a file for explaining particular terms, or a file for explaining questions.

According to one or more embodiments of the present invention, a method of inducing a learner to log into a learning content-providing server, which is performed by a learner terminal, includes displaying an e-book; if one of a plurality of URL information included in the e-book is selected, accessing a location in the learning content-providing server, which corresponds to the selected URL information; receiving and playing a learning content file, which is stored in the location in the learning content-providing server; and if a period or number of times the received learning content file is played expires, accessing the learning content-providing server, and request to extend the period or number of times the learning content file is played.

The learning content file may be at least one of a video file for the e-book, a video file that includes a detailed explanation of a particular part, a three-dimensional (3D) image file for a two-dimensional (2D) image, a file for explaining particular terms, or a file for explaining questions.

According to one or more embodiments of the present invention, a method of inducing a learner to log into a learning content-providing server, which is performed by the learning content-providing server, includes: if a learner terminal accesses a location in which a learning content file is stored through URL information, transmitting a learning content file to the learner terminal; and if the learner terminal frequently accesses the location and requests for extending a period or number of times the learning content file is played, extending the period or number of times the learning content file is played, or providing points by which a relevant textbook may be purchased free of charge or at a discounted price.

The providing of the points may include: if extending of the period or number of times the learning content file is played is requested by the learner terminal, transmitting a menu for extending the period or number of times the learning content file is played;

if a menu for evaluating a video clip or a textbook is selected from the menu, receiving an input of an evaluation of a video clip or a textbook from the learner terminal; if a menu for additionally inputting personal information is selected from the menu, receiving an additional input of personal information; and if a menu for payment or point subtraction is selected from the menu, paying a preset cost or subtracting preset points.

The learning content file may be at least one of a video file for the e-book, a video file that includes a detailed explanation of a particular part, a three-dimensional (3D) image file for a two-dimensional (2D) image, a file for explaining particular terms, or a file for explaining questions.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating a learning content-providing system according to an embodiment of the present invention;

FIG. 2 is an internal configuration diagram of a learner terminal that accesses a learning content-providing server according to an embodiment of the present invention;

FIG. 3 is a flowchart for explaining a process of accessing the learning content-providing server so as to download a learning content file, which is performed by the learner terminal, according to an embodiment of the present invention;

FIG. 4 is a flowchart for explaining a process of accessing the learning content-providing server so as to update a period or number of times a downloaded learning content file is played, which is performed by the learner terminal, according to an embodiment of the present invention; and

FIG. 5 is a flowchart for explaining a process of accessing the learning content-providing server through uniform resource locator (URL) information that is inserted into a downloaded e-book, which is performed by the learner terminal, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As the invention allows for various changes and numerous embodiments, particular embodiments will be illustrated in the drawings and described in detail in the written description. The attached drawings for illustrating exemplary embodiments of the present invention are referred to in order to gain a sufficient understanding of the present invention, the merits thereof, and the objectives accomplished by the implementation of the present invention. The invention may, however, be embodied in many different forms and should not be construed as being limited to the embodiments set forth herein.

It will be understood that, although the terms, ‘first’, ‘second’, etc. may be used herein to describe various elements, these elements should not be limited by these terms. These terms are only used to distinguish one element from another. An expression used in the singular encompasses the expression of the plural, unless it has a clearly different meaning in the context.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In the embodiments of the present invention, terms “communication”, “communication network, “internet network”, and “network” may have the same meaning. The above terms refer to a wired or wireless, short-range or wide-area data transceiving network via which data may be transceived between a user terminal, a terminal of other users, and a download server.

The present invention will now be described more fully with reference to the accompanying drawings, in which exemplary embodiments of the invention are shown.

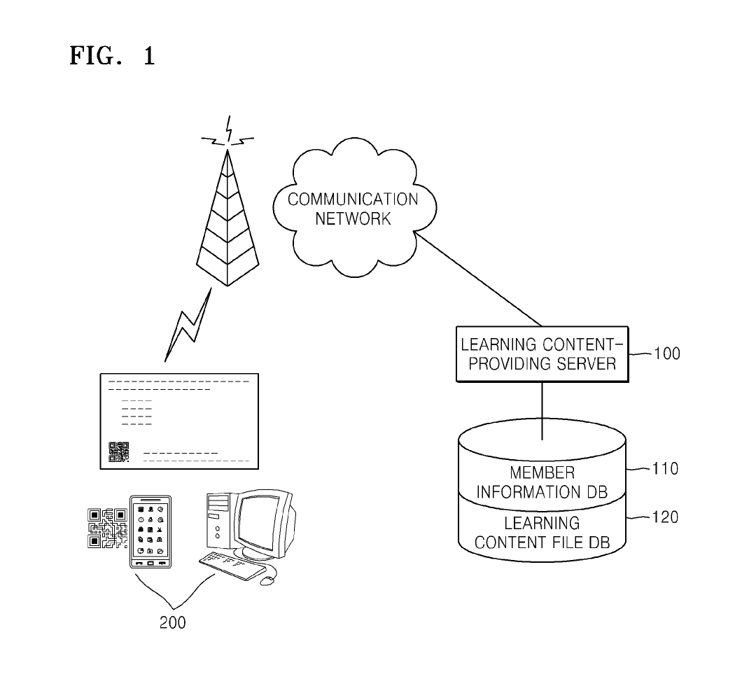

FIG. 1 is a diagram illustrating a learning content-providing system 100 according to an embodiment of the present invention.

The learning content-providing server 100 may be configured as hardware or, software in a computing apparatus that users may access. A plurality of programs may be operated in one learning content-providing server 100, and according to a function of the server, one or more learning content-providing server 200 may be present.

At least a part of components, which constitute the learning content-providing server 100, may be configured as software that includes at least one from among an operating system, an application program module, and another program module and, physically, may be stored in various types of memory apparatuses.

Additionally, the learning content-providing server 100 may be connected to middleware for a database or servers for processing payment. However, in the present invention, a description thereof will not be provided.

The learner terminal 200 may be a laptop computer, a hand-held apparatus, a mobile terminal such as a smartphone or a tablet personal computer (PC), a desktop computer, or an appropriate arbitrary apparatus that uses or is directly or indirectly connected to the above-mentioned apparatuses.

The learning content-providing server 100 includes a member information database 110 for storing information about members who receive a learning content file.

Additionally, the learning content-providing server includes a learning content file database 120 for matching and storing a video file that corresponds to a learning content file, a video file that includes a detailed explanation of a particular part, a three-dimensional (3D) image file, a file for explaining particular terms, or a file for explaining questions with a two-dimensional (2D) barcode or uniform resource locator (URL) information that corresponds thereto.

Digital rights management (DRM) may not be set for the learning content file. Alternately, DRM may be set for the learning content file. In this case, a period or number of times the learning content file is played is preset in advance when the learning content file is downloaded.

Upon a request by the learner terminal 200, the learning content-providing server 100 transmits a learning content file, which is stored in the learning content file database 120, to the learner terminal 200.

Additionally, whenever registered members log in, the learning content-providing server extends a limit on the period or number of times the learning content file is played, or provides points by which a member may purchase a relevant textbook free of charge or at a discounted price.

The learner terminal 200 captures a 2D barcode that is printed in the textbook, and displays information that is obtained by reading the captured 2D barcode on a screen.

The information that is obtained by reading the 2D barcode is URL information, and the URL information shows a location in the learning content-providing server 200, in which the corresponding learning content file is stored.

Alternately, URL information that is printed in the textbook may be input directly to the learner terminal 200.

Upon a request by the learner, the learner terminal 200 accesses a location in the learning content-providing server 100, in which the corresponding learning content file is stored, by using 2D barcode information, that is, the URL information.

Additionally, the learner terminal 200 receives and displays a list of learning content files, stored in the accessed location, and requests to download the learning content file.

Then, the learner terminal 200 downloads and stores the learning content file.

Then, when a period or number of times the stored learning content file is played expires, the learner terminal 200 accesses the learning content-providing server 100, and requests the learning content-providing server 100 to extend the period or number of times the stored learning content file is played.

A method of extending the period or number of times the learning content file is played may be preset by the learning content-providing server 100. According to embodiments of the present invention, it is assumed that a method of providing an evaluation of a video clip or a textbook, a method of additionally inputting personal information, and a method of paying a certain cost or subtracting a certain points are set.

Additionally, if an e-book is to be downloaded and used, the learner terminal 200 plays the e-book via an e-book viewer program.

In this case, the learner terminal 200 accesses the learning content-providing server 100 and downloads the e-book in advance.

Additionally, while the e-book is played, the learner terminal 200 accesses the location in the learning content-providing server 100, in which the corresponding learning content file is stored, by using URL information included in the e-book.

The learning content file may be a video file of the e-book, a video file that includes a detailed explanation of a specific part, a 3D image file of a particular image, a file for explaining particular terms, or a file for explaining questions.

The learner terminal 200 downloads the corresponding learning content file from the learning content-providing server 100, and displays the learning content file.

Then, if a period or number of times the downloaded learning content file is played expires, and thus, the learning content file is not played, the learner terminal 200 accesses the learning content-providing server 100, and requests the learning content-providing server 100 to extend the period or number of times the learning content file is played.

According to an embodiment of the present invention, it is described that the learner terminal 200 downloads a learning content file from the learning content-providing server 100. However, a learning content file may be provided and displayed in real time through a streaming service.

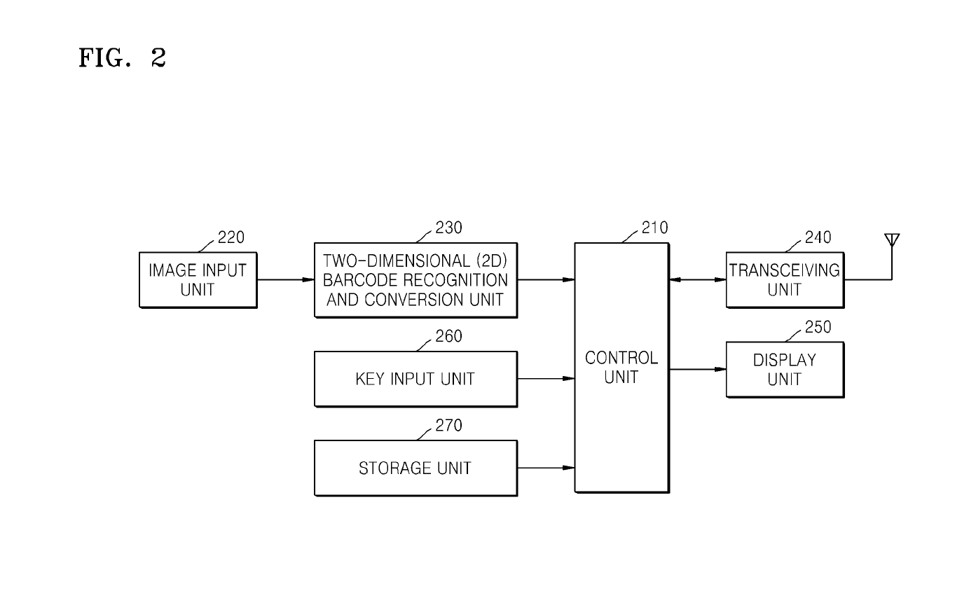

FIG. 2 is an internal configuration diagram of the learner terminal 200 that accesses the learning content-providing server 100 according to an embodiment of the present invention.

A control unit 210 controls all operations of the learner terminal 200.

When requested to capture a 2D barcode, the control unit 210 controls an image input unit 220 to capture a 2D barcode that is printed in a textbook.

Then, the control unit 210 reads the 2D barcode that is captured via a 2D barcode recognition and conversion unit 230, and displays URL information, which is obtained through the read 2D barcode information, via a display unit 250.

The control unit 210 accesses a location in the learning content-providing server 100, which corresponds to URL information, by using the URL information.

Additionally, the control unit 210 downloads and stores a learning content file stored in the location, which corresponds to the URL information.

When an e-book viewer program is executed, the control unit 210 displays a list of e-books that may be read.

The list of the e-books that may be read may be a list of textbooks that are downloaded in advance.

When a particular e-book is selected from the list of the e-books, the control unit 210 displays the particular e-book via the display unit 250.

Then, if one of the plurality of URL information that are displayed on the e-book is selected, the control unit 210 accesses a location in the learning content-providing server 100, which corresponds to the selected URL information.

Additionally, the control unit 210 downloads and stores a learning content file that is stored in the location, which corresponds to the URL information.

Then, if a period or number of times the stored learning content file is played expires, the learner terminal 200 accesses the learning content-providing server 100.

The image input unit 220 receives image data and transmits the received image data to the 2D barcode recognition and conversion unit 230.

When receiving an input of a 2D barcode from the image input unit 220, the 2D barcode recognition and conversion unit reads the input 2D barcode, and transmits 2D barcode information that is obtained by reading the 2D barcode to the control unit 210.

A transceiving unit 240 transceives data, and particularly, under control by the control unit 210, accesses a location in the learning content-providing server 100, which corresponds to the URL information, and thus, receives a pre-stored learning content file.

The display unit 250 displays a 2D barcode which is captured or URL information which is input under control by the control unit 210, displays an e-book that is executed via an e-book viewer program, and displays a learning content file that is transmitted through the URL information.

A key input unit 260 may be implemented as a touchscreen on the display unit 250 or implemented in a key matrix structure.

The storage unit 270 stores an e-book view program, and stores a learning content file received from a location in the learning content-providing server 100, which corresponds to a URL information (address).

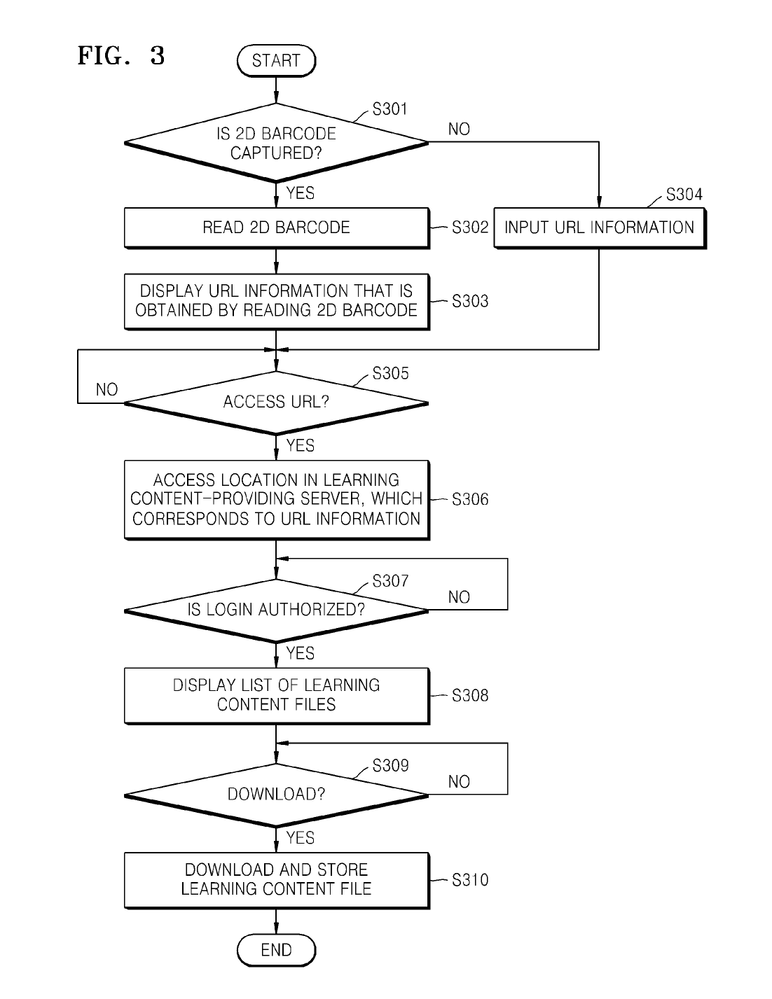

FIG. 3 is a flowchart for explaining a process of accessing the learning content-providing server so as to download a learning-content file, which is performed by the learner terminal 200, according to an embodiment of the present invention.

When a 2D barcode is captured in operation S301, the learner terminal 200 reads the captured 2D barcode in operation S302, and displays URL information that is obtained by reading the 2D barcode in operation S303.

If a 2D barcode is not captured in operation S301, the learner terminal 200 may receive an input of URL information and display the URL information in operation S304.

When receiving a request for accessing the displayed URL information in operation S305, the learner terminal 200 accesses a location in the learning content-providing server 100, which corresponds to the URL information, in operation S306.

Then, the learner terminal 200 receives a request for transmitting login information from the learning content-providing server 100, and transmits login information, input from a learner, to the learning content-providing server 100.

The login information may be an identification (ID) and a password which the learner input to the learning content-providing server 100 when the learner registered for membership.

When login is authorized by the learning content-providing server 100 in operation S307, the learner terminal 200 receives a list of learning content files, which are stored in a location that is accessed by using URL information, from the learning content-providing server 100.

The learning content file may be at least one of a video file, a 3D image file, a file for explaining particular terms, or a file for explaining questions.

If downloading of a displayed learning content file is selected in operation S309, the learner terminal 200 downloads the learning content file from the learning content-providing server 100, and stores the learning content file.

DRM may not be set for the downloaded file. Alternately, DRM may be set for the downloaded file if necessary, so that a period or number of times the file is played may be limited.

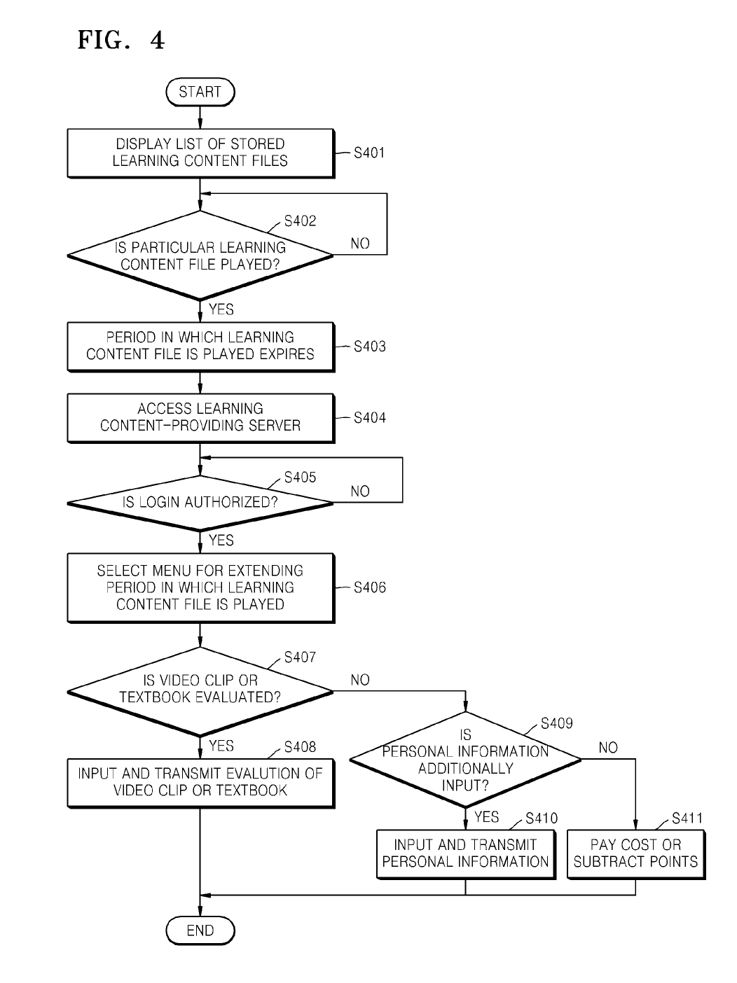

FIG. 4 is a flowchart for explaining a process of accessing the learning content-providing server 100 so as to update a period or number of times a downloaded learning content file is played, which is performed by the learner terminal 200, according to an embodiment of the present invention.

When receiving a request for displaying a list of stored learning content files, the learner terminal 200 displays a list of learning contents files, which are stored in advance, in operation S401.

Then, if playing of a particular learning content file is requested in operation S402, the learner terminal 200 determines a period or number of times the learning content file is played.

If it is determined that the period or number of times the learning content file is played has expired in operation S403, the learner terminal 200 accesses the learning content-providing server 100 in operation S404, so as to extend the period or number of times the learning content file is played.

Then, if receiving a request for transmitting login information from the learning content-providing server 100, the learner terminal 200 requests login by transmitting login information, input from a learner, to the learning content-providing server 100.

The login information may be an ID and a password which the learner input to the learning content-providing server 100 when the learner registered for membership.

When login is authorized by the learning content-providing server 100 in operation S405, the learner terminal 200 selects a menu for extending a period or number of times the learning content file is played, from menus that may be executed via the learning content-providing server 100, in operation S406.

The menu for extending a period or number of times the learning content file is played may be preset by the learning content-providing server 100. According to an embodiment of the present invention, it is assumed that the menu for extending a period or number of times the learning content file is played is set to interwork with a menu for providing an evaluation of a video clip or a textbook, a menu for additionally inputting personal information, and a menu for subtracting cost or points.

If receiving a selection of the menu for providing an evaluation of a video clip or a textbook from the preset menu for extending a period or number of times the learning content file is played in operation S407, the learner terminal 200 receives an input of an evaluation of the video clip or the textbook from the learner and transmits the evaluation to the learning content-providing server 100 in operation S408.

If receiving a selection of the menu for additionally inputting personal information from the menu for extending the period or number of times the learning content file is played in operation S409, the learner terminal 200 receives an additional input of personal information and transmits the evaluation to the learning content-providing server 100 in operation S410. In other words, the learner terminal 200 may extend a period or number of times the learning content file is played, by additionally providing personal information, requested by the learning content-providing server 100, from among personal information that has not been input before.

If receiving a selection of the menu for subtracting cost or points in operation S411, the learner terminal 200 requests the learning content-providing server 100 for payment of certain cost or subtraction of certain points.

As such, in the present invention, a period or number of times a downloaded learning content file is played may be extended by using points, additionally inputting personal information, or performing an evaluation on learning content.

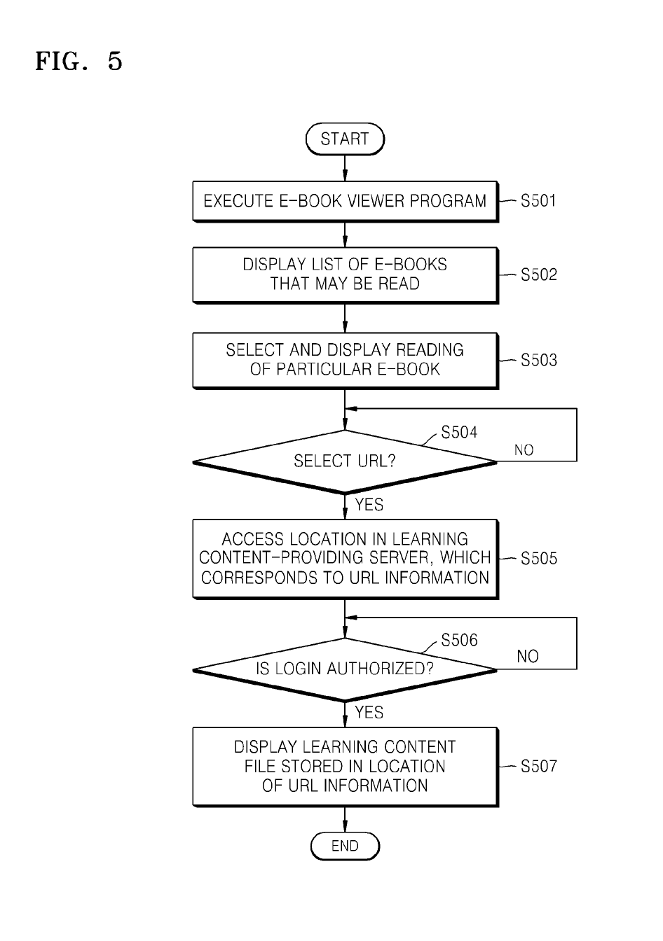

FIG. 5 is a flowchart for explaining a process of accessing the learning content-providing server 100 through URL information that is inserted into a downloaded e-book, which is performed by the learner terminal 200, according to an embodiment of the present invention.

If an e-book viewer program is executed in operation S501, the learner terminal 200 displays a list of e-books that may be read, in operation S502.

The list of the e-books that may be read may be a list of e-books that is obtained when a learner accesses the learning content-providing server 100 and downloads the e-books in advance.

In operation S503, if a particular e-book to be read is selected, the learner terminal 200 displays the selected e-book.

Then, while the learner terminal 200 displays the e-book, if URL information included in the e-book is selected in operation S504, the learner terminal 200 accesses a location in the learning content-providing server 100, which corresponds to the URL information, in operation S505.

Then, if receiving a request for transmitting login information from the learning content-providing server 100, the learner terminal 200 receives an input of login information from a learner, and transmits the login information to the learning content-providing server 100.

The login information may be an ID and a password which the learner input to the learning content-providing server 100 when the learner registered for a membership

When login is authorized by the learning content-providing server 100 in operation S506, the learner terminal 200 receives a learning content file, which is stored in a location of the corresponding URL information, and displays the learning content file in operation S507.

By doing so, the learner may frequently access the learning content-providing server 100 while studying with a textbook, and be provided with various learning contents that are provided by the learning content-providing server 100.

According to embodiments of the present invention, by limiting a period or number of times a learning content file for a textbook or an e-book that is downloaded through a learner terminal is played, a learner may frequently access a learning content-providing server, so as to update the period or number of times the learning content file is played. Additionally, according to embodiments of the present invention, since points are provided to a member whenever the member logs into the learning content-providing server, a period or number of times the learning content file is played may be updated or a relevant textbook may be purchased free of charge or at a discounted price by using the points. Thus, a learner may be induced to frequently access the learning content-providing server.

As described above, according to the one or more of the above embodiments of the present invention, since a period or number of times a learning content file for a textbook or an e-book that is downloaded through a learner terminal is played is limited, a learner may frequently access the learning content-providing server, so as to update the period or number of times the learning content file is played.

Additionally, according to the one or more of the above embodiments of the present invention, since URL information for explaining particular terms or questions is inserted into a textbook or an e-book, a learner may be induced to frequently access the learning content-providing server while studying, so as to download and use explanations of the particular terms and questions.

Additionally, according to the one or more of the above embodiments of the present invention, since points are provided to a member whenever the member logs into the learning content-providing server, a period or number of times the learning content file is played may be updated or a relevant textbook may be purchased free of charge or at a discounted price by using the points. Thus, a learner may be induced to frequently access the learning content-providing server.

In addition, other embodiments of the present invention can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present invention. The media may also be a distributed network, so that the computer readable code is stored/transferred and executed in a distributed fashion. Furthermore, the processing element could include a processor or a computer processor, and processing elements may be distributed and/or included in a single device.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of inducing a learner to log into a learning content-providing server, which is performed by a learner terminal, the method comprising:
receiving an input of uniform resource locator (URL) information that is printed in a textbook;
accessing a location in the learning content-providing server, which corresponds to the URL information;
receiving and playing a learning content file, which is stored in the location in the learning content-providing server; and
if a period or number of times the received learning content file is played expires, accessing the learning content-providing server and requesting to extend the period or number of times the learning content file is played.

2. The method of claim 1, wherein the receiving of the input of the URL information comprises:
capturing a two-dimensional (2D) barcode that is printed in a textbook; and
reading the captured 2D barcode, and displaying URL information that is extracted through the reading of the captured 2D barcode.

3. The method of claim 1, wherein the learning content file is at least one of a video file for the textbook, a video file that comprises a detailed explanation of a particular part, a three-dimensional (3D) image file for a 2D image, a file for explaining particular terms, or a file for explaining questions.

4. A method of inducing a learner to log into a learning content-providing server, which is performed by a learner terminal, the method comprising:
displaying an e-book;
if one of a plurality of URL information comprised in the e-book is selected, accessing a location in the learning content-providing server, which corresponds to the selected URL information;
receiving and playing a learning content file, which is stored in the location in the learning content-providing server; and
if a period or number of times the received learning content file is played expires, accessing the learning content-providing server, and requesting to extend the period or number of times the learning content file is played.

5. The method of claim 4, wherein the learning content file is at least one of a video file for the e-book, a video file that comprises a detailed explanation of a particular part, a three-dimensional (3D) image file for a two-dimensional (2D) image, a file for explaining particular terms, or a file for explaining questions.

6. A method of inducing a learner to log into a learning content-providing server, which is performed by the learning content-providing server, the method comprising:
if a learner terminal accesses a location in which a learning content file is stored through URL information, transmitting a learning content file to the learner terminal; and
if the learner terminal frequently accesses the location and requests to extend a period or number of times the learning content file is played, extending the period or the number of times the learning content file is played, or providing points by which a relevant textbook may be purchased free of charge or at a discounted price.

7. The method of claim 6, wherein the providing of the points comprises:
if extending of the period or number of times the learning content file is played is requested by the learner terminal, transmitting a menu for extending the period or number of times the learning content file is played;
if a menu for evaluating a video clip or a textbook is selected from the menu, receiving an input of an evaluation of a video clip or a textbook from the learner terminal;
if a menu for additionally inputting personal information is selected from the menu, receiving an additional input of personal information; and
if a menu for payment or point subtraction is selected from the menu, paying a preset cost or subtracting preset points.

8. The method of claim 6, wherein the learning content file is at least one of a video file for the e-book, a video file that comprises a detailed explanation of a particular part, a three-dimensional (3D) image file for a two-dimensional (2D) image, a file for explaining particular terms, or a file for explaining questions.
